(19) United States
(12) Patent Application Publication
(10) Pub. No.: US 2022/0198532 A1
(43) Pub. Date: Jun. 23, 2022

(54) CONSUMER COMMENTS STORAGE METHOD, ELECTRONIC DEVICE, AND STORAGE MEDIUM

(71) Applicant: HON HAI PRECISION INDUSTRY CO., LTD., New Taipei (TW)

(72) Inventor: YUHG-CHANG TAI, New Taipei (TW)

(21) Appl. No.: 17/524,912

(22) Filed: Nov. 12, 2021

(30) Foreign Application Priority Data
Dec. 22, 2020 (CN) 202011531631.8

(51) Int. Cl. G06Q 30/02; G06Q 20/40; G06Q 20/38

(52) U.S. Cl. CPC G06Q 30/0282; G06Q 2220/00; G06Q 20/389; G06Q 20/40

(57) ABSTRACT

A consumer comments storage method and an electronic device are disclosed. In response to a user requesting to make a comment on a target commodity, the method acquires an authorization certificate from a payment platform and obtains a first commodity purchase record of the user according to the authorization certificate. When the target commodity is recorded in the first commodity purchase record, it is determined that the user has a right to comment on the target commodity. A command on the target commodity entered by the user is received and the comment and the authorization certificate are uploaded to a blockchain to enable a smart contract of the blockchain to verify the comment. A verification result returned by the blockchain is received and when the returned result is a verification successful result, the comment is retained. The storing of comments in the blockchain ensures the authenticity of the comments.

### FIELD

The present disclosure relates to a technical field of data processing, specifically a consumer comments storage method, an electronic device and a storage medium.

### BACKGROUND

When people are considering a purchase of something, they will look at other people's comments for reference, but in practice, the comments may not be genuine. There may be false comments on goods by non-purchasers, and there may also have been some tampering with genuine comments, which leads to the low authenticity of the comments.

Therefore, ensuring the authenticity of comments is a technical problem.

### BRIEF DESCRIPTION OF THE DRAWINGS

FIG. 1 shows a flowchart of a consumer comments storage method provided in an embodiment of the present disclosure.

FIG. 2 shows a schematic structural diagram of a consumer comments storage device provided in an embodiment of the present disclosure.

FIG. 3 shows a schematic structural diagram of an electronic device applying the consumer comments storage method provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the consumer comments storage method of the present disclosure is applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a voice control device.

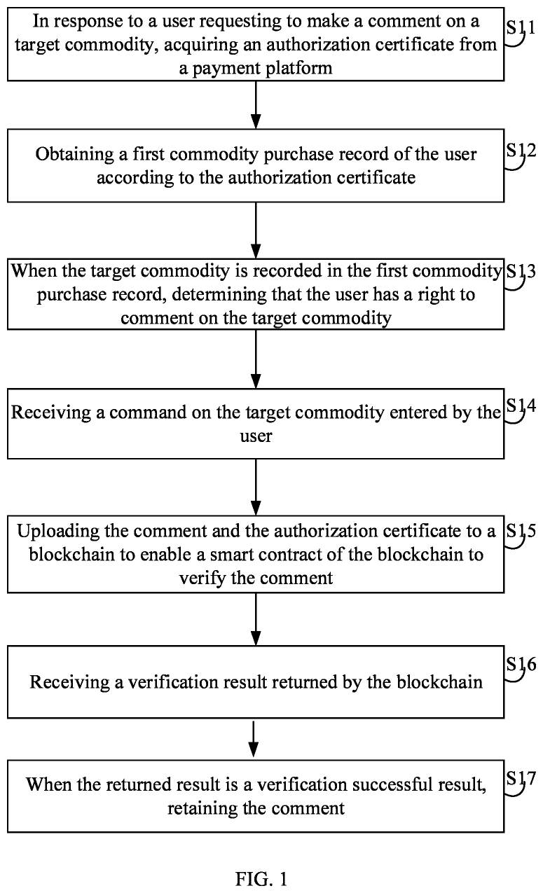

FIG. 1 is a flowchart of a consumer comments storage method in an embodiment of the present disclosure. The consumer comments storage method regarding purchased commodities is applied to electronic devices. According to different needs, the order of the steps in the flowchart can be changed, and some can be omitted.

In block S11, in response to a user requesting to make a comment on a target commodity, acquiring an authorization certificate from a payment platform.

In at least one embodiment, the method of acquiring the authorization certificate from a payment platform includes: obtaining an authorization confirmation page of the payment platform; in response to receiving an authorization confirmation instruction in the authorization confirmation page, requesting an authorization certificate from the payment platform; receiving the authorization certificate sent by the payment platform.

The authorization certificate is a character string or a password with a certain time limit, which is used as authorization to obtain information from the payment platform.

If a user enters an authorization confirmation instruction in the authorization confirmation page, a request of authorization certificate is sent to the payment platform, and an authorization certificate is received from the payment platform. If a user enters an authorization rejection instruction in the authorization confirmation page, a prompt can be output, such as “Without Authorization, unable to make comment.”

In block S12, obtaining a first commodity purchase record of the user according to the authorization certificate.

Through the authorization certificate, the first commodity purchase record can be obtained from the payment platform. The first commodity purchase record stores historical information of all commodities purchased by the user through the payment platform.

In block S13, when the target commodity is recorded in the first commodity purchase record, determining that the user has a right to comment on the target commodity.

In an embodiment of the present disclosure, after obtaining the first commodity purchase record, it is determined whether the target commodity is recorded in the first commodity purchase record. When the target commodity is recorded in the first commodity purchase record, indicating that the user has made a purchase of the target commodity, and it is determined that the user has the right to comment on the target commodity, the authenticity of the comment being ensured. That is, the user is allowed to comment on the target commodity. The user having the right to comment on the target commodity refers to allowing the user to comment on the target commodity. In this way, the authenticity of the comments are ensured.

In other embodiments, when the target commodity is not recorded in the first commodity purchase record, the consumer comments storage method prohibits the user from commenting on the target commodity.

In the above embodiment, when the target commodity is not recorded in the first commodity purchase record, this signifies that the user has no standing in relation to the target commodity, and thus it is determined that the user does not have the right to comment on the target commodity. A user without standing being allowed to comment on the target commodity reduces the value of the comment may. Therefore, the authenticity of the comment is increased by prohibiting a user without standing from commenting on the target commodity.

In some embodiments, when the target commodity is not recorded in the first commodity purchase record, prompt may also be output to remind the user that the user does not have the right to comment on the target commodity.

In block S14, receiving a command on the target commodity entered by the user.

In an embodiment of the present disclosure, after determining that the user has the right to comment on the target commodity, a comment entered by the user can be received. The command is specific in relation to the target commodity.

In the block S15, uploading the comment and the authorization certificate to a blockchain to enable a smart contract of the blockchain to verify the comment.

The comment and the authorization certificate are uploaded to a blockchain, then a smart contract of the blockchain verifies the comment and generates a verification result. The verification result is returned by the blockchain to the electronic device.

The blockchain is a distributed data storage system, with point-to-point transmission and consensus mechanism, and encryption algorithm. Each block or link of a blockchain contains data as to a transaction or other event, and when each block is closed the data therein is recorded and fixed on a multitude of different, distributed, storage systems. Validity of the information (for anti-counterfeiting) is based on a consensus or majority view among all the different storage systems. The next block or link in the chain can then be opened to include an encrypted (hashed) summary of the previous block or link. The blockchain can include an underlying platform of the blockchain, a platform commodity service layer, and an application service layer.

The smart contract can be a preset computer program on the blockchain, automatically executed, which responds to received information, and can receive, store, and send data.

Each commodity corresponds to one smart contract, each smart contract is used to manage comments in relation to the commodity. When it is desired to make a comment on a certain commodity, a smart contract can be called to provide services, which improves efficiency.

In some embodiments, the method of uploading the comment and the authorization certificate to a blockchain to enable a smart contract of the blockchain to verify the comment includes: sending the authorization certificate to the smart contract, and obtaining a second commodity purchase record of the user in the payment platform through the smart contract; determining whether a commodity corresponding to the comment is recorded in the second commodity purchase record; when the commodity corresponding to the comment is recorded in the second commodity purchase record, returning a verification successful result; when the commodity corresponding to the comment is not recorded in the second commodity purchase record, returning a verification failure result.

In the above embodiment, the authorization certificate can be passed as a parameter to the smart contract, the smart contract can be automatically executed, and the user's second commodity purchase record in the payment platform can be retrieved according to the authorization certificate. By determining whether a commodity corresponding to the comment is recorded in the second commodity purchase record, it is determined whether the verification result is a verification failure. In this way, an authenticity and legality of the comment can be ensured.

In block S16, receiving a verification result returned by the blockchain.

The verification result returned by the blockchain may be a verification successful result or a verification failure result.

In block S17, when the returned result is a verification successful result, retaining the comment.

If the verification result is that the verification is successful, it indicates that the comment is legal and the comment can be retained. The comment cannot be tampered with, and the authenticity of the comment information can be ensured.

In another embodiment, when the returned result is a verification failure result, the consumer comments storage method further includes: deleting the comment; generating a prompt and sending the prompt to a terminal of the user.

When the verification fails (that is, the verification result is that the verification is failure), it indicates that the comment is illegal or has been illegally changed. That is, the comment is an illegal comment. By deleting the illegal comment and generating a prompt for the illegal comment, it can be ensured that the comments stored in the blockchain are all authentic.

In another embodiment, the consumer comments storage method further includes: receiving a request to display all comments made in relation to the target commodity; acquiring a plurality of comments made in relation to the target commodity from the blockchain; and outputting the plurality of comments.

In the above embodiment, when receiving a request to display commands in relation to the target commodity, all comments in relation to the target product obtained from the blockchain are output to the user, and the user is able to make a better-informed choice in relation to the commodity.

The present disclosure ensures that comments made are authentic and genuine by checking the commodity purchase records of the payment platform, and tampering with the comments is prevented by storing the comments in the blockchain, further ensuring the authenticity of the comments.

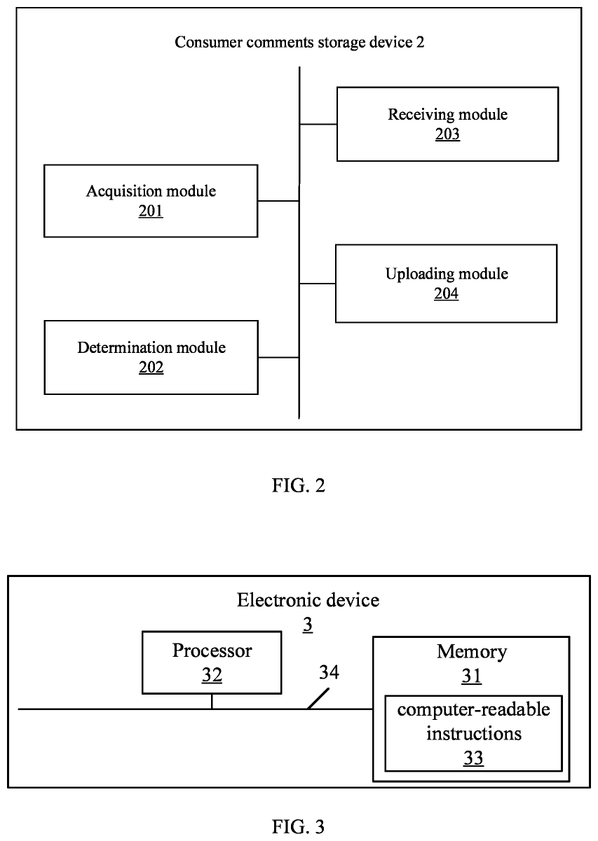

FIG. 2 shows a schematic structural diagram of a consumer comments storage device provided in the embodiment of the present disclosure.

In some embodiments, the consumer comments storage device 2 runs in an electronic device. The consumer comments storage device 2 can include a plurality of function modules consisting of program code segments. The program code of each program code segments in the consumer comments storage device 2 can be stored in a memory and executed by at least one processor to perform comment verification (described in detail in FIG. 2).

As shown in FIG. 2, the consumer comments storage device 2 can include: an acquisition module 201, a determination module 202, a receiving module 203, and an uploading module 204. The modules referred to in the present disclosure refer to a series of computer-readable instruction segments that can be executed by at least one processor and that are capable of performing fixed functions, which are stored in a memory. In some embodiment, the functions of each module will be detailed.

The above-mentioned modules can be integrated units implemented in a form of software functional modules can be stored in a non-transitory readable storage medium. The functional modules are stored in a storage medium and include several instructions for causing an electronic device (which can be a personal computer, a dual-screen device, or a network device) or a processor to execute the method described, in various embodiments in the present disclosure.

The acquisition module 201, in response to a user requesting to make a comment on a target commodity, acquiring an authorization certificate from a payment platform.

In at least one embodiment, the acquisition module 201 acquiring the authorization certificate from a payment platform includes: obtaining an authorization confirmation page of the payment platform; in response to receiving an authorization confirmation instruction in the authorization confirmation page, requesting an authorization certificate from the payment platform; receiving the authorization certificate sent by the payment platform.

The authorization certificate is a character string or a password with a certain time limit, which is used as authorization to obtain information from the payment platform.

If a user enters an authorization confirmation instruction in the authorization confirmation page, a request of authorization certificate is sent to the payment platform, and an authorization certificate is received from the payment platform. If a user enters an authorization rejection instruction in the authorization confirmation page, a prompt can be output, such as “Without Authorization, unable to make comment.”

The acquisition module 201 obtains a first commodity purchase record of the user according to the authorization certificate.

Through the authorization certificate, the first commodity purchase record can be obtained from the payment platform. The first commodity purchase record stores historical information of all commodities purchased by the user through the payment platform.

The determination module 202, when the target commodity is recorded in the first commodity purchase record, determines that the user has a right to comment on the target commodity.

In an embodiment of the present disclosure, after obtaining the first commodity purchase record, it is determined whether the target commodity is recorded in the first commodity purchase record. When the target commodity is recorded in the first commodity purchase record, indicating that the user has made a purchase of the target commodity, and it is determined that the user has the right to comment on the target commodity, the authenticity of the comment being ensured. That is, the user is allowed to comment on the target commodity. The user having the right to comment on the target commodity refers to allowing the user to comment on the target commodity. In this way, the authenticity of the comments are ensured.

In other embodiments, when the target commodity is not recorded in the first commodity purchase record, the consumer comments storage device prohibits the user from commenting on the target commodity.

In the above embodiment, when the target commodity is not recorded in the first commodity purchase record, this signifies that the user has no standing in relation to the target commodity, and thus it is determined that the user does not have the right to comment on the target commodity. A user without standing being allowed to comment on the target commodity reduces the value of the comment may. Therefore, the authenticity of the comment is increased by prohibiting a user without standing from commenting on the target commodity.

In some embodiments, when the target commodity is not recorded in the first commodity purchase record, prompt may also be output to remind the user that the user does not have the right to comment on the target commodity.

The receiving module 203 receives a command on the target commodity entered by the user.

In an embodiment of the present disclosure, after determining that the user has the right to comment on the target commodity, a comment entered by the user can be received. The command is specific in relation to the target commodity.

The uploading module 204 uploads the comment and the authorization certificate to a blockchain to enable a smart contract of the blockchain to verify the comment.

The comment and the authorization certificate are uploaded to a blockchain, then a smart contract of the blockchain verifies the comment and generates a verification result. The verification result is returned by the blockchain to the electronic device.

The blockchain is a distributed data storage system, with point-to-point transmission and consensus mechanism, and encryption algorithm. Each block or link of a blockchain contains data as to a transaction or other event, and when each block is closed the data therein is recorded and fixed on a multitude of different, distributed, storage systems. Validity of the information (for anti-counterfeiting) is based on a consensus or majority view among all the different storage systems. The next block or link in the chain can then be opened to include an encrypted (hashed) summary of the previous block or link. The blockchain can include an underlying platform of the blockchain, a platform commodity service layer, and an application service layer.

The smart contract can be a preset computer program on the blockchain, automatically executed, which responds to received information, and can receive, store, and send data.

Each commodity corresponds to one smart contract, each smart contract is used to manage comments in relation to the commodity. When it is desired to make a comment on a certain commodity, a smart contract can be called to provide services, which improves efficiency.

In some embodiments, the uploading module 204 uploading the comment and the authorization certificate to a blockchain to enable a smart contract of the blockchain to verify the comment includes: sending the authorization certificate to the smart contract, and obtaining a second commodity purchase record of the user in the payment platform through the smart contract; determining whether a commodity corresponding to the comment is recorded in the second commodity purchase record; when the commodity corresponding to the comment is recorded in the second commodity purchase record, returning a verification successful result; when the commodity corresponding to the comment is not recorded in the second commodity purchase record, returning a verification failure result.

In the above embodiment, the authorization certificate can be passed as a parameter to the smart contract, the smart contract can be automatically executed, and the user's second commodity purchase record in the payment platform can be retrieved according to the authorization certificate. By determining whether a commodity corresponding to the comment is recorded in the second commodity purchase record, it is determined whether the verification result is a verification failure. In this way, an authenticity and legality of the comment can be ensured.

The receiving module 203 receives a verification result returned by the blockchain.

The verification result returned by the blockchain may be a verification successful result or a verification failure result.

The determination module 202, when the returned result is a verification successful result, retains the comment.

If the verification result is that the verification is successful, it indicates that the comment is legal and the comment can be retained. The comment cannot be tampered with, and the authenticity of the comment information can be ensured.

In another embodiment, the consumer comments storage device 20 further includes a deleting module. The deleting module, when the returned result is a verification failure result, deletes the comment; generates a prompt and sends the prompt to a terminal of the user.

When the verification fails (that is, the verification result is that the verification is failure), it indicates that the comment is illegal or has been illegally changed. That is, the comment is an illegal comment. By deleting the illegal comment and generating a prompt for the illegal comment, it can be ensured that the comments stored in the blockchain are all authentic.

In another embodiment, the receiving module 203 receives a request to display all comments made in relation to the target commodity; the acquisition module 201 acquires a plurality of comments made in relation to the target commodity from the blockchain; and outputs the plurality of comments.

In the above embodiment, when receiving a request to display commands in relation to the target commodity, all comments in relation to the target product obtained from the blockchain are output to the user, and the user is able to make a better-informed choice in relation to the commodity.

The present disclosure ensures that comments made are authentic and genuine by checking the commodity purchase records of the payment platform, and tampering with the comments is prevented by storing the comments in the blockchain, further ensuring the authenticity of the comments.

The embodiment also provides a non-transitory readable storage medium having computer-readable instructions stored therein. The computer-readable instructions are executed by a processor to implement the steps in the above-mentioned consumer comments storage method, such as in steps in blocks S11-S17 shown in FIG. 1:

In block S11, in response to a user requesting to make a comment on a target commodity, acquiring an authorization certificate from a payment platform;

In block S12, obtaining a first commodity purchase record of the user according to the authorization certificate;

In block S13, when the target commodity is recorded in the first commodity purchase record, determining that the user has a right to comment on the target commodity;

In block S14, receiving a command on the target commodity entered by the user;

In the block S15, uploading the comment and the authorization certificate to a blockchain to enable a smart contract of the blockchain to verify the comment;

In block S16, receiving a verification result returned by the blockchain;

In block S17, when the returned result is a verification successful result, retaining the comment.

The computer-readable instructions are executed by the processor to realize the functions of each module/unit in the above-mentioned device embodiments, such as the modules 201-204 in FIG. 2:

The acquisition module 201, in response to a user requesting to make a comment on a target commodity, acquires an authorization certificate from a payment platform;

The acquisition module 201 obtains a first commodity purchase record of the user according to the authorization certificate;

The determination module 202, when the target commodity is recorded in the first commodity purchase record, determines that the user has a right to comment on the target commodity;

The receiving module 203 receives a command on the target commodity entered by the user;

The uploading module 204 uploads the comment and the authorization certificate to a blockchain to enable a smart contract of the blockchain to verify the comment;

The receiving module 203 receives a verification result returned by the blockchain;

The determination module 202, when the returned result is a verification successful result, retains the comment.

FIG. 3 is a schematic structural diagram of an electronic device provided in an embodiment of the present disclosure. The electronic device 3 may include: a memory 31, at least one processor 32, computer-readable instructions 33 stored in the memory 31 and executable on the at least one processor 32, for example, consumer comments storage programs, and a communication bus 34. The processor 32 executes the computer-readable instructions to implement the steps in the embodiment of the consumer comments storage method, such as in steps in block S11-S17 shown in FIG. 1. Alternatively, the processor 32 executes the computer-readable instructions to implement the functions of the modules/units in the foregoing device embodiments, such as the modules 201-204 in FIG. 2.

For example, the computer-readable instructions can be divided into one or more modules/units, and the one or more modules/units are stored in the memory 31 and executed by the at least one processor 32. The one or more modules/units can be a series of computer-readable instruction segments capable of performing specific functions, and the instruction segments are used to describe execution processes of the computer-readable instructions in the electronic device 3. For example, the computer-readable instruction can be divided into the acquisition module 201, the determination module 202, the receiving module 203, and the uploading module 204 as in FIG. 2.

The electronic device 3 can be an electronic device such as a desktop computer, a notebook, a palmtop computer, and a cloud server. Those skilled in the art will understand that the schematic diagram 3 is only an example of the electronic device 3 and does not constitute a limitation on the electronic device 3. Another electronic device 3 may include more or fewer components than shown in the figures or may combine some components or have different components. For example, the electronic device 3 may further include an input/output device, a network access device, a bus, and the like.

The at least one processor 32 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 32 can be a microprocessor or any conventional processor. The processor 32 is a control center of the electronic device 3 and connects various parts of the entire electronic device 3 by using various interfaces and lines.

The memory 31 can be configured to store the computer-readable instructions and/or modules/units. The processor 32 may run or execute the computer-readable instructions and/or modules/units stored in the memory 31 and may call up data stored in the memory 31 to implement various functions of the electronic device 3. The memory 31 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 3. In addition, the memory 31 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

When the modules/units integrated into the electronic device 3 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A consumer comments storage method, the method comprising:
in response to a user requesting to make a comment on a target commodity, acquiring an authorization certificate from a payment platform;
obtaining a first commodity purchase record of the user according to the authorization certificate;
when the target commodity is recorded in the first commodity purchase record, determining that the user has a right to comment on the target commodity;
receiving a command on the target commodity entered by the user;
uploading the comment and the authorization certificate to a blockchain to enable a smart contract of the blockchain to verify the comment;
receiving a verification result returned by the blockchain;
when the returned result is a verification successful result, retaining the comment.

2. The consumer comments storage method of claim 1, wherein uploading the comment and the authorization certificate to a blockchain to enable a smart contract of the blockchain to verify the comment comprises:
sending the authorization certificate to the smart contract, and obtaining a second commodity purchase record of the user in the payment platform through the smart contract;
determining whether a commodity corresponding to the comment is recorded in the second commodity purchase record;
when the commodity corresponding to the comment is recorded in the second commodity purchase record, returning a verification successful result;
when the commodity corresponding to the comment is not recorded in the second commodity purchase record, returning a verification failure result.

3. The consumer comments storage method of claim 1, wherein acquiring the authorization certificate from a payment platform comprises:
obtaining an authorization confirmation page of the payment platform;
in response to receiving an authorization confirmation instruction in the authorization confirmation page, requesting an authorization certificate from the payment platform;
receiving the authorization certificate sent by the payment platform.

4. The consumer comments storage method of claim 1, further comprising:
receiving a request to display all comments made in relation to the target commodity;
acquiring a plurality of comments made in relation to the target commodity from the blockchain; and
outputting the plurality of comments.

5. The consumer comments storage method of claim 2, further comprising:
prohibiting the user from commenting on the target commodity when the target commodity is not recorded in the first commodity purchase record.

6. The consumer comments storage method of claim 1, further comprising:
deleting the comment when the returned result is a verification failure result;
generating a prompt and sending the prompt to a terminal of the user.

7. The consumer comments storage method of claim 1, wherein each commodity corresponds to one smart contract, each smart contract being used to manage comments in relation to the commodity.

8. An electronic device comprising a memory and a processor, the memory stores at least one computer-readable instruction, which when executed by the processor causes the processor to:
in response to a user request for making a comment on a target commodity, acquire an authorization certificate from a payment platform;
obtain a first commodity purchase record of the user according to the authorization certificate;
when the target commodity is recorded in the first commodity purchase record, determine that the user has a right to comment on the target commodity;
receive a command on the target commodity entered by the user;
upload the comment and the authorization certificate to a blockchain to enable a smart contract of the blockchain to verify the comment;
receive a verification result returned by the blockchain;
when the returned result is a verification successful result, retain the comment.

9. The electronic device of claim 8, wherein the processor uploads the comment and the authorization certificate to a blockchain to enable a smart contract of the blockchain to verify the comment by:
sending the authorization certificate to the smart contract, and obtaining a second commodity purchase record of the user in the payment platform through the smart contract;
determining whether a commodity corresponding to the comment is recorded in the second commodity purchase record;
when the commodity corresponding to the comment is recorded in the second commodity purchase record, returning a verification successful result;
when the commodity corresponding to the comment is not recorded in the second commodity purchase record, returning a verification failure result.

10. The electronic device of claim 9, wherein the processor acquires the authorization certificate from a payment platform by:
obtaining an authorization confirmation page of the payment platform;
in response to receiving an authorization confirmation instruction in the authorization confirmation page, requesting an authorization certificate from the payment platform;
receiving the authorization certificate sent by the payment platform.

11. The electronic device of claim 10, wherein the processor is further caused to:
receive a request to display all comments made in relation to the target commodity;
acquire a plurality of comments made in relation to the target commodity from the blockchain; and
output the plurality of comments.

12. The electronic device of claim 8, wherein the processor is further caused to:
prohibit the user from commenting on the target commodity, when the target commodity is not recorded in the first commodity purchase record.

13. The electronic device of claim 8, wherein the processor is further caused to:
delete the comment, when the returned result is a verification failure result;
generate a prompt and send the prompt to a terminal of the user.

14. The electronic device of claim 8, wherein each commodity corresponds to one smart contract, each smart contract being used to manage comments is in relation to the commodity.

15. A non-transitory storage medium having stored thereon at least one computer-readable instructions that, when the at least one computer-readable instructions are executed by a processor to implement a consumer comments storage method, which comprises:
in response to a user requesting to make a comment on a target commodity, acquiring an authorization certificate from a payment platform;
obtaining a first commodity purchase record of the user according to the authorization certificate;
when the target commodity is recorded in the first commodity purchase record, determining that the user has a right to comment on the target commodity;
receiving a command on the target commodity entered by the user;
uploading the comment and the authorization certificate to a blockchain to enable a smart contract of the blockchain to verify the comment;
receiving a verification result returned by the blockchain;
when the returned result is a verification successful result, retaining the comment.

16. The non-transitory storage medium of claim 15, wherein uploading the comment and the authorization certificate to a blockchain to enable a smart contract of the blockchain to verify the comment comprises:
sending the authorization certificate to the smart contract, and obtaining a second commodity purchase record of the user in the payment platform through the smart contract;
determining whether a commodity corresponding to the comment is recorded in the second commodity purchase record;
when the commodity corresponding to the comment is recorded in the second commodity purchase record, returning a verification successful result;
when the commodity corresponding to the comment is not recorded in the second commodity purchase record, returning a verification failure result.

17. The non-transitory storage medium of claim 16, wherein acquiring the authorization certificate from a payment platform comprises:
in response to receiving an authorization confirmation instruction in the authorization confirmation page, requesting an authorization certificate from the payment platform;
receiving the authorization certificate sent by the payment platform.

18. The non-transitory storage medium of claim 17, the method further comprising:
receiving a request to display all comments made in relation to the target commodity;
acquiring a plurality of comments made in relation to the target commodity from the blockchain; and
outputting the plurality of comments.

19. The non-transitory storage medium of claim 15, wherein the method further comprises:
prohibiting the user from commenting on the target commodity when the target commodity is not recorded in the first commodity purchase record.

20. The non-transitory storage medium of claim 15, wherein the method further comprises:
deleting the comment, when the returned result is a verification failure result;
generating a prompt and sending the prompt to a terminal of the user.
